(19) United States
(12) Patent Application Publication
(10) Pub. No.: US 2006/0159805 A1
(43) Pub. Date: Jul. 20, 2006

(54) Powderous formulations of fat-soluble active ingredients

(76) Inventors: Elger Funda, Grenzach-Wyhien (DE); Torsten Huber, Magden (CH)

Correspondence Address: NIXON & VANDERHYE, PC, 901 NORTH GLEBE ROAD, 11TH FLOOR, ARLINGTON, VA, 22203, US

(21) Appl. No.: 10/564,635

(22) PCT Filed: Jul. 6, 2004
(86) PCT No.: PCT/EP04/07367

§ 371 Date: Jan. 13, 2006

(30) Foreign Application Priority Data
Jul. 15, 2003 (EP) 03016054.3

(51) Int. Cl. A23L 1/30; A23J 1/00

(52) U.S. Cl. 426/72; 426/656

(57) ABSTRACT

Stable powderous formulations comprising a fat-soluble active ingredient such as a fat-soluble vitamin, and a milk protein such as a caseinate are disclosed. They can be used as additives for feed, food, beverages and cosmetics.

The present invention is concerned with novel stable powderous formulations comprising a fat-soluble active ingredient, ans a process for their preparation. The novel compositions of this invention can be used as additives for food, beverages, animal feeds, cosmetics or drugs to incorporate said fat-soluble ingredients into such application forms.

More specifically, the present invention is concerned with stable powderous formulations comprising a fat-soluble active ingredient in a matrix of a milk protein composition.

As used herein, the term “milk protein” denotes any native protein found in milk, particularly cow milk, and partially hydrolyzed proteins obtained therefrom, such as caseinates and hydrolyzed or partially hydrolyzed caseinates, lactoglobulines, whey proteins or milk powder and their hydrolyzates which can be obtained by known methods (e.g., by a acidic or alcaline treatment of the protein, or by enzymatic treatment with a protease) with degree of hydrolysis (DH) of, e.g., up to 25%, up to 15%, or up to 10%. Especially preferred are caseinates such as sodium caseinates, and hydrolyzates or partially hydrolyzed caseinates, whey protein isolates or hydrolyzed whey proteins having a protein content of more than 80% by weight and degree of hydrolysis of up to 25%, up to 15%, or up to 10%.

In one aspect of the invention, the novel formulations may additionally contain carbohydrates or carbohydrate derivatives that act as protective coating material, e.g. dextrines, sugar syrup, pectines, carragenans, starch and starch derivatives, celluloses or cellulose derivatives like carboxymethyl cellulose, plant proteins or partially hydrolized plant proteins that act as protective colloids, e.g. as obtained from potato protein, soy protein, wheat protein, pea protein, rice protein or lupin protein. In a particular aspect of the invention, a plant protein hydrolysate is used at least 80% of which has a molecular weight distribution below 2500 Daltons. Such additional carbohydrates or carbohydrate derivatives or proteins may be present in the formulations of the invention in an amount of from 2-20 wt.-% based on the total amount of carbohydrates ot protein in the dry formulation. The use of mixtures with carbohydrates or carbohydrydate derivatives or plant proteins or plant protein hydrolysates may reduce loss of active ingredient in thermal treatment of the formulation and may improve stability of active ingredient. The term “milk protein composition” thus comprises milk protein and/or partially hydrolyzed milk proteins as well as mixtures thereof with carbohydrates or carbohydrate derivatives and/or plant proteins or hydrolyzed plant proteins.

The term “fat-soluble active ingredient” as used herein denotes any physiologically active ingredient that is soluble in lipids and insoluble or sparingly soluble in water. Examples of such fat-soluble active ingredients are fat-soluble vitamins, viz., vitamin A, D, E and K and derivatives thereof such as vitamin A esters, e.g. vitamin A acetate and palmitate, and vitamin E esters, e.g. tocopherol acetate; carotenoids and carotinoid derivatives, e.g., are α- or β-carotene, 8′-apo-β-carotenal, 8′-apo-β-carotenoic acid esters such as the ethyl ester, canthaxanthin, astaxanthin, astaxanthin esters, lycopene, lutein, zeaxanthin or crocetin and their derivatives; polyunsaturated fatty acids, e.g. eicosapentaenoic acid, docosahexaenoic acid, arachidonic acid and and γ-linolenic acid and/or ethylester. Such fat-soluble ingredients can be present in the formulations according to the present invention in an amount of up to 55% by weight. In another aspect of the invention, the novel formulations additionally contain a reducing sugar, e.g. glucose, fructose, xylose, or a reducing sugar derivative, e.g., a desoxy sugar such as 2-desoxy-D-ribose or rhamnose, or an amino sugar e.g., a glucosamine such as 2-amino-2-desoxy-D-glucose. The sugar can be present in an amount of up to 15% by weight, preferably, 5-15% by weight, especially 5-9% by weight, based on the dry mass of the formulation. Such formulations can be submitted to heat-treatment to cause cross-linking of the sugar with the protein in a Maillard type reaction. Crosslinking can be also achieved by treatment with enzymes like transglutaminase. The cross-linked formulations have been found to exhibit increased stability.

Particular aspects of the present invention relate to formulations wherein the milk protein composition is:

A caseinate, especially sodium caseinate;

a mixture of caseinate, especially sodium caseinate, and a reducing sugar, e.g. fructose;

a mixture of caseinate, especiall sodium caseinate, a hydrolyzed plant protein, especially rice or soy or potato protein, and a reducing sugar, e.g. fructose;

a mixture of caseinate, especially sodium caseinate, and a carbohydrate or carbohydrate derivative and/or hydrolyzed plant protein, especially hydrolyzed rice or soy or potato protein, and a reducing sugar, e.g. fructose;

a mixture of hydrolyzed caseinate, especially hydrolyzed sodium caseinate, and a reducing sugar, e.g. fructose;

a mixture of hydrolyzed caseinate, especiall hydrolized sodium caseinate, a hydrolyzed plant protein, especially rice or soy or potato protein, and a reducing sugar, e.g. fructose;

a mixture of hydrolyzed caseinate, especially hydrolyzed sodium caseinate, and a carbohydrate or carbohydrate derivative and/or hydrolyzed plant protein, especially hydrolyzed rice or soy or potato protein, and a reducing sugar, e.g. saccharose.

In accordance with the invention, the novel formulations can be obtained by a process which comprises preparing an aqueous emulsion of the fat-soluble active ingredient and the milk protein composition, if desired, adding a reducing sugar, converting the emulsion into a dry powder and, if required, submitting the dry powder to cross-linking the sugar with the protein by heat treatment or cross-linking the protein by treatment with a cross-linking enzyme.

Suitably, in a first step of the process of the invention, the milk protein composition is dispersed in water. Thereafter, the fat-soluble active ingredient is emulsified, suitably in liquid state, i.e. with adequate warming and/or as a solution in an appropriate solvent, into the aqueous dispersion of the protein. Alternatively a suspension of the solid active may be produced by appropriate procedures like nimiig. The emulsion is then, optionally after removal of excess solvent, sprayed . The spraying can effected be using conventional technology of spray-drying, spray drying in combination with fluidized-bed granulation (the latter technique commonly known as fluidized spray drying or FSD), or by a powder-catch technique where sprayed emulsion droplets are caught in a bed of an absorbant such as starch or calcium silicate or silicic acid or calcium carbonate or mixtures thereof and subsequently dried.

Finally, in a still fturther aspect, the present invention is concerned with food, beverages, animal feeds, cosmetics and drugs which comprise the novel formulations of the present invention.

The novel formulations of this invention may further contain adjuvants and/or excipients such as one or more of a mono- di-, oligo- or polysaccharide, a triglyceride, a water-soluble antioxidant, a fat-soluble antioxidant, humectants such as glycerol, sorbitol, polyethylene glycol, propylene glycol, extenders and solubilizers., silicic acid, Ca-silicate, Ca-carbonate and water.

Examples of mono- and disaccharides which may further be present in the formulations of the present invention are saccharose, invert sugar, glucose, fructose, xylose, lactose and maltose. Examples of oligo- or polysaccharides which may further be present in the compositions of the present invention are xanthan gum, acacia gum, pectins, guar, caroub gums, alginates, cefluloses, cellulose derivatives like carboxymethylcellulose, starch, modified starch and starch hydrolysates, such as dextrins and maltodextrins, especially such in the range of 5-65 dextrose equivalents (hereinafter: DE) and glucose syrup, especially such in the range of 20-95 DE. The term “dextrose equivalent” (DE) denotes the degree of hydrolysation and is measure for the amount of reducing sugar calculated as D-glucose based on dry weight. Native starch has DE close to 0 while glucose has a DE=100.

The triglyceride is suitably a vegetable oil or fat, such as corn oil, sunflower oil, soybean oil, safflower oil, rape seed oil, peanut oil, arachis oil, palm oil, palm kernel oil, cotton seed oil or cocos oil.

The water-soluble antioxidant may be ascorbic acid and salts thereof, e.g., sodium ascorbate, and the like. The fat-soluble antioxidant may be a tocopherol, e.g., dl-α-tocopherol (i.e., synthetic tocopherol), d-α-tocopherol (i.e., natural tocopherol), β- and γ-tocopherol and mixtures thereof, ascorbic acid esters of fatty acids such as ascorbyl palmitate or stearate; butyl hydroxy toluene (BHT); butyl hydroxy anisol (BHA); propyl gallate; or t-butyl hydroxy quinoline; or 6-ethoxy-1,2-dihydroxy-2,2,4-trimethylquinoline (EMQ).

The following Examples illustrate the invention further.

### EXAMPLE 1

75 g of sodium caseinate were added to 300 ml of water and 13.2 g of glycerol. The mixture was warmed to 60° C. until dissolution occurred. To this solution, 15.1 g of sugar fructose were added and the pH of the solution was adjusted to 6.5±0.2. Thereafter, 52.3 g of vitamin A acetate (2,1×10⁶ IE vitamin A/g stabilized with Ethoxyquin) were emulsified into the matrix solution whereupon the mixture was stirred for 45 minutes at 60° C. The inner phase of the emulsion then exhibited a mean particle size of about 350 nm. The emulsion was then diluted with ca. 100 ml of water and about 300 g of the emulsion was sprayed in a spraying pan in a bed of Ca-silicate at about 5° C. by means of a rotating spraying nozzle. The so-obtained beadlets werde separated from excess Ca-silicate by sieving and dried. There were obtained ca. 120 g of dry powder having a vitamin A content of ca. 750'000 IEA/g.

50 g of the so-obtained dry powder were cross-linked by thermically treating the powder at 135° C. in a rotating dryer for 30 minutes. The so-obtained product had a vitamin A content of ca. 450'000 IE per g and was insoluble in hot water.

### EXAMPLE 2

75 g of hydrolyzed sodium caseinate with a DH of around 3.5% were added to 300 ml of water and 13.2 g of glycerol. The mixture was warmed to 60° C. until dissolution occurred. To this solution, 15.1 g of sugar fructose were added and the pH of the solution was adjusted to 6.5±0.2. Thereafter, 52.3 g of vitamin A acetate (2,1×10⁶ IE vitamin A/g stabilized with Ethoxyquin) were emulsified into the matrix solution whereupon the mixture was stirred for 45 minutes at 60° C. The inner phase of the emulsion then exhibited a mean particle size of about 350 nm. The emulsion was then diluted with ca. 100 ml of water and about 300 g of the emulsion was sprayed in a spraying pan in a bed of Ca-silicate at about 5° C. by means of a rotating spraying nozzle. The so-obtained beadlets werde separated from excess Ca-silicate by sieving and dried. There were obtained ca. 100 g of dry powder having a vitamin A content of ca. 750'000 IEA/g. 50 g of the so-obtained dry powder were cross-linked by thermicaily treating the powder at 125° C. in a fluidized bed dryer for 30 minutes. The so-obtained product had a vitamin A content of ca. 500'000 IE per g and was insoluble in hot water.

### EXAMPLE 3

72.4 g of sodium caseinate and 8 g of soy protein hydrolysate (molecular weight distribution <2000 D ≅90%) were added to 300 ml of water and 9.5 g of glycerol and dissolved at 60° C. To this solution, 14.5 g of sugar fructose were added and the pH of the solution was adjusted to 6.5±0.2. Thereafter, 48 g of vitamin A acetate (2,1×10⁶ IE vitamin A/g stabilized with Ethoxyquin) were emulsified into the matrix solution whereupon the mixture was stirred for 45 minutes at 60° C. The inner phase of the emulsion then exhibited a mean particle size of about 380 nm. About 300 g of the emulsion was sprayed in a spraying pan in analogy to the procedure described in Example 1. There were obtained about 100 g of dry powder having a vitamin A content of ca. 735'000 IE per g.

50 g of the so-obtained dry powder were cross-linked by thermically treating the powder at 125° C. in a fluidized bed dryer for 30 minutes. The so-obtained product had a vitamin A content of ca. 605000 IE per g and was insoluble in hot water.

1. Stable powderous formulations comprising a fat-soluble active ingredient in a matrix of a milk protein composition, wherein the protein is thermally cross-linked with a reducing sugar or a reducing sugar derivative.

2. Formulations according to claim 1, wherein the milk protein composition is a native milk protein or partially hydrolyzed milk protein with a degree of hydrolysis of up to 25% or mixtures thereof having a protein content of more than 80 wt-%.

3. Formulations according to claim 1, wherein the milk protein composition is a native milk protein or partially hydrolyzed milk protein with a degree of hydrolysis of up 15% or mixtures thereof having a protein content of more than 80 wt. %.

4. Formulations according to claim 1, wherein the milk protein composition is a native milk protein or partially hydrolyzed milk protein with a degree of hydrolysis of up 10% or mixtures thereof having a protein content of more than 80 wt. %.

5. Formulations according to claim 1, wherein the milk protein is a caseinate or partially hydrolyzed caseinate.

6. Formulations according to claim 1, wherein the milk protein composition contains additionally a plant protein or plant protein hydrolysate or mixture thereof.

7. Formulations according to claim 6 wherein the average molecular weight of at least 80% of the plant protein hydrolysate is below 2500 Daltons.

8. Formulations according to claim 6, wherein the plant protein or plant protein hydrolysate is obtained from potato protein, soy protein, wheat protein, pea protein, rice protein or lupin protein.

9. Formulations according to claim 1, wherein the milk protein composition contains additionally a carbohydrate or carbohydrate derivative, e.g. saccharose, invert sugar, glucose, fructose, xylose, lactose, maltose, xanthan gum, acacia gum, pectins, guar, caroub gums, alginates, celluloses, cellulose derivatives, starch, modified starch and starch hydrolysates, such as dextrins and maltodextrins, especially such in the range of 5-65 dextrose equivalents (hereinafter DE) and glucose syrup, especially such in the range of 20-95 DE.

10. Formulations according to claim 1 further comprising an adjuvant.

11. Formulations according to claim 10 wherein the adjuvant is calcium silicate, silicic acid, starch or calcium carbonate, or mixture thereof

12. Formulations according to claim 1, wherein the fat-soluble active ingredient is vitamin A, D, E or K, or a carotenoid, or a polyunsaturated fatty acid, or esters thereof, or mixtures thereof.

13. Formulations according to claim 12, wherein the fat-soluble active ingredient is mixed with a plant or animal oil or fat, e.g. sunflower oil, palm oil or corn oil.

14. Formulations according to claim 1 wherein the reducing sugar is glucose, fructose, saccharose or xylose.

15. Stable powderous formulations comprising a fat-soluble active ingredient in a matrix of a milk protein composition, wherein the milk protein is a partially hydrolyzed milk protein with a degree of hydrolysis of 3.5% to 25%.

16. Food, beverages, animal feeds, cosmetics or drugs comprising a formulation according to claim 1.

17. Process for the preparation of formulations according to claim 1, which comprises preparing an aqueous emulsion of the fat-soluble active ingredient and the milk protein composition, adding a reducing sugar or a reducing sugar derivative, converting the emulsion into a dry powder, and submitting the dry powder to cross-linking the protein by heat treatment.
